(19) United States
(12) Patent Application Publication
(10) Pub. No.: US 2026/0074565 A1
(43) Pub. Date: Mar. 12, 2026

(54) WIRELESS POWER TRANSMISSION SYSTEM

(71) Applicant: MAKITA CORPORATION, Anjo-shi (JP)

(72) Inventor: Tomoyuki MIZOJIRI, Anjo-shi (JP)

(73) Assignee: MAKITA CORPORATION, Anjo-shi (JP)

(21) Appl. No.: 19/318,449

(22) Filed: Sep. 4, 2025

(30) Foreign Application Priority Data
Sep. 10, 2024 (JP) 2024-156649

(51) Int. Cl. H02J 50/12; H02J 7/00; H02J 50/00; H02J 50/40; H02M 1/12

(52) U.S. Cl. CPC H02J 50/12; H02J 7/50; H02J 7/731; H02J 50/005; H02J 50/402; H02M 1/12

(57) ABSTRACT

One aspect of the present disclosure provides a wireless power transmission system including a power transmission device and a power receiving device. The power receiving device includes a first power receiving circuit including three receiving coils connected in a delta configuration. The three receiving coils are configured (i) to be magnetically coupled with two or more transmitting coils in the power transmission device and (ii) to output a first polyphase AC power in response to two or more single-phase alternating currents being supplied to the two or more transmitting coils, respectively.

### CROSS-REFERENCE TO RELATED APPLICATIONS

This application claims the benefit of Japanese Patent Application No. 2024-156649 filed on Sep. 10, 2024 with the Japan Patent Office, the entire disclosure of which is incorporated herein by reference.

### BACKGROUND

The present disclosure relates to a wireless power transmission.

Japanese Unexamined Patent Application Publication No. 2016-197931 discloses a wireless power transmission device that transmits electric power wirelessly between a transmitting coil and a receiving coil. A power receiving device of the wireless power transmission device is provided with a filter to remove harmonics.

### SUMMARY

In the aforementioned wireless power transmission device, the larger the electric power to be transmitted, the larger the filter can be.

It is desirable that one aspect of the present disclosure can inhibit enlargement of a filter circuit for removing harmonics from wirelessly transmitted electric power.

One aspect of the present disclosure provides a wireless power transmission system including a power transmission device and a power receiving device.

The power transmission device includes a first power transmission circuit and a power supply circuit.

The first power transmission circuit includes two or more transmitting coils. The two or more transmitting coils are separated from each other.

The power supply circuit is configured to supply two or more single-phase alternating currents to the two or more transmitting coils, respectively. The two or more single-phase alternating currents have an identical frequency but differ in phase from each other.

The power receiving device includes a first power receiving circuit and a conversion circuit.

The first power receiving circuit includes three receiving coils connected in a delta configuration. The three receiving coils are configured (i) to be magnetically coupled with the two or more transmitting coils and (ii) to output a first polyphase AC power in response to the two or more single-phase alternating currents being supplied to the two or more transmitting coils, respectively.

The conversion circuit is configured to convert the first polyphase AC power into first DC power.

In such a wireless power transmission system, the electric power transmitted to the first power receiving circuit includes third harmonic components. However, such third harmonic components circulate within the delta configuration and do not flow out of the delta configuration. Accordingly, this wireless power transmission system does not require a filter circuit to remove the third harmonic components. The filter circuit may be sufficient for this wireless power transmission system if it can remove fifth and higher-order harmonic components included in the transmitted electric power. Thus, the enlargement of the filter circuit can be inhibited.

### BRIEF DESCRIPTION OF THE DRAWINGS

Example embodiments of the present disclosure will be described hereinafter with reference to the accompanying drawings, in which:

FIG. 1 is a perspective view of a wireless power transmission system in a first embodiment;

FIG. 2 is a circuit diagram of the wireless power transmission system in the first embodiment;

FIG. 3 is a waveform diagram showing third harmonic components;

FIG. 4 illustrates the third harmonic components circulating within a delta configuration;

FIG. 5 is a circuit diagram of a variation of the first embodiment;

FIG. 6 is a circuit diagram of a wireless power transmission system in a second embodiment;

FIG. 7 is a circuit diagram of a wireless power transmission system in a third embodiment; and

FIG. 8 is a waveform diagram showing that fifth harmonic components are suppressed.

### DETAILED DESCRIPTION OF EXEMPLARY EMBODIMENTS

### 1. Overview of Embodiments

In the present disclosure, languages such as “first” and “second” merely intend to distinguish one element from another. Such languages do not intend to limit the order or the number of elements. Accordingly, a first element may be referred to as a second element; and likewise, a second element may be referred to as a first element. In addition, a first element may be included without a second element; and likewise, a second element may be included without a first element.

One embodiment may provide a wireless power transmission system including at least any one of:
Feature 1: a power transmission device;
Feature 2: the power transmission device includes a first power transmission circuit including two or more transmitting coils;
Feature 3: the two or more transmitting coils are separated from each other;
Feature 4: the power transmission device includes a power supply circuit (or a power delivery circuit);
Feature 5: the power supply circuit is configured to supply (or deliver) two or more single-phase alternating currents to the two or more transmitting coils, respectively;
Feature 6: the two or more single-phase alternating currents have an identical frequency but differ in phase from each other;
Feature 7: a power receiving device;
Feature 8: the power receiving device includes a first power receiving circuit that includes three receiving coils connected (or coupled) in a delta configuration;
Feature 9: the three receiving coils are configured (i) to be magnetically coupled with the two or more transmitting coils and (ii) to output a first polyphase AC power in response to the two or more single-phase alternating currents being supplied to the two or more transmitting coils, respectively; and
Feature 10: the power receiving device includes a conversion circuit configured to convert the first polyphase AC power into first DC power.

In the wireless power transmission system including at least Features 1 through 10, third harmonic components are inhibited from flowing out of the delta configuration. Accordingly, it is sufficient for such a wireless power transmission system to have a filter for removing fifth and higher-order harmonic components. As a result, the enlargement of the filter can be inhibited.

One embodiment may include, in addition to or in place of at least any one of Features 1 through 10, at least any one of:
Feature 11: the conversion circuit includes a first rectifier circuit configured to rectify the first polyphase AC power into the first DC power; and
Feature 12: the conversion circuit includes a filter circuit configured to remove unnecessary harmonic components from the first DC power obtained by the first rectifier circuit.

The wireless power transmission system including at least Features 1 through 12 can remove, from the first DC power, not only the third harmonic components but also the unnecessary harmonic components.

One embodiment may include, in addition to or in place of at least any one of Features 1 through 12, at least any one of:
Feature 13: the two or more transmitting coils include three transmitting coils;
Feature 14: the two or more single-phase alternating currents include three single-phase alternating currents that differ in phase from each other by 120 degrees;
Feature 15: the power supply circuit is configured to supply the three single-phase alternating currents to the three transmitting coils, respectively; and
Feature 16: the three transmitting coils are configured to receive the three single-phase alternating currents to thereby simulate the delta configuration.

In the wireless power transmission system including at least Features 1 through 10 and 13 through 16, even in a case where any one of the three transmitting coils fails, power transmission can be continued by the remaining transmitting coils. If the three transmitting coils were actually connected in the delta configuration, the power transmission could stop when any one of the three transmitting coils fails.

One embodiment may include, in addition to or in place of at least any one of Features 1 through 16, at least any one of:
Feature 17: the first power transmission circuit includes two or more capacitors configured to form two or more series resonant circuits together with the two or more transmitting coils;
Feature 18: the first power receiving circuit includes three additional capacitors configured to form three additional series resonant circuits together with the three receiving coils; and
Feature 19: the two or more series resonant circuits and the three additional series resonant circuits are each configured to resonate at the identical frequency.

In the wireless power transmission system including at least Features 1 through 10 and 17 through 19, the three receiving coils resonate with a magnetic field generated by the two or more transmitting coils to thereby generate a new magnetic field. Consequently, the new magnetic field excites resonance in the two or more transmitting coils. The three receiving coils and the two or more transmitting coils repeat such operations, thereby generating magnetic resonance between the three receiving coils and the two or more transmitting coils. As a result, compared to the power transmission through electromagnetic coupling, the power transmission efficiency can be improved. In addition, this configuration can increase a degree of freedom in the relative position between the power transmission device and the power receiving device.

One embodiment may include, in addition to or in place of at least any one of Features 1 through 19, at least any one of:
Feature 20: a second power receiving circuit that is distinct from the first power receiving circuit;
Feature 21: the second power receiving circuit (i) includes three additional receiving coils connected (or coupled) in a delta configuration or in a star configuration and (ii) is configured to output a second polyphase AC power; and
Feature 22: the conversion circuit includes a second rectifier circuit that is configured (i) to rectify the second polyphase AC power into second DC power and (ii) to combine the second DC power with the first DC power in parallel.

In the wireless power transmission system including at least Features 1 through 10 and 20 through 22, the power receiving device can be enhanced to improve its capability. Specifically, in a case where the second power receiving circuit includes the three additional receiving coils connected in the star configuration, the second power receiving circuit inhibits output of not only the third harmonic components but also fifth harmonic components and seventh harmonic components. Accordingly, what the wireless power transmission system requires is a filter circuit for removing eleventh and higher-order harmonic components. Accordingly, it is possible to further downsize the filter circuit.

One embodiment may include, in addition to or in place of at least any one of Features 1 through 22,
Feature 23: the power receiving device is (i) a job-site electrical device (or an outdoor power equipment (OPE)) or (ii) a battery pack for the job-site electrical device.

The wireless power transmission system including at least Features 1 through 10 and 23 can supply the electric power wirelessly to the job-site electrical device or its battery pack.

Examples of the job-site electrical device include, but are not limited to, power equipment configured to be used at job-sites, such as building sites, manufacturing sites, gardening sites, and construction sites, and specifically include, but are not limited to, power equipment (or electric power tools) for masonry work, metalworking, and woodworking, and power equipment for gardening.

More specifically, examples of the job-site electrical device include, but are not limited to, an electric driver, an electric wrench, an electric drill, an electric hammer drill, an electric chain saw, an electric circular saw, an electric reciprocating saw, an electric jig saw, an electric cutter, an electric hammer, an electric planer, an electric grinder, an electric blower, an electric nailing machine (including tacker), an electric hedge trimmer, an electric lawn mower, an electric lawn trimmer, an electric bush/grass cutter, an electric trowel, an electric vibrator, an electric rammer, an electric compactor, an electric pump, an electric pile driver, an electric concrete saw, an electric screed, an electric cut-off saw, an electric sprayer, an electric spreader, an electric cleaner, an electric dust collector (or an electric dust extractor), a robot vacuum cleaner, a robot lawn mower, an electric earth auger, an electric scarifier, an electric air pump (or an electric inflator), an electric lubricator (e.g., an electric grease gun), a fan vest, an electric heated jacket, an electric fan, a laser range finder (or a laser distance measuring equipment), a laser level, an electric beam receiver of a laser level, a wall scanner, a radio, a television, a speaker, a light (i.e., a lighting device), an electric hot/cool storage, an electric kettle, a coffee machine (or a coffee maker or a coffee distiller), a microwave oven, a portable power supply, and a power distributor.

One embodiment may include, in addition to or in place of at least any one of Features 1 through 23,
Feature 24: the conversion circuit is configured to supply at least the first DC power to a battery cell for the job-site electrical device.

The wireless power transmission system including at least Features 1 through 10, 23, and 24 can charge the battery cell with at least the first DC power.

One embodiment may include, in addition to or in place of at least any one of Features 1 through 24, at least any one of:
Feature 25: the power transmission device includes a second power transmission circuit that is distinct from the first power transmission circuit;
Feature 26: the second power transmission circuit includes two or more additional transmitting coils; and
Feature 27: the two or more additional transmitting coils include three additional transmitting coils.

The wireless power transmission system including at least Features 1 through 10, 25, and 26 can further suppress the harmonic components included in the first DC power output from the first power receiving circuit, if two or more additional single-phase alternating currents respectively supplied to the two or more additional transmitting coils in the second power transmission circuit are out of phase with the two or more single-phase alternating currents respectively supplied to the two or more transmitting coils in the first power transmission circuit.

In one embodiment, Features 1 through 27 may be combined in any combination.

In one embodiment, any of Features 1 through 27 may be excluded.

### 2. Specific Example Embodiments

Some specific example embodiments of the present disclosure will be described below with reference to the drawings.

### 2-1. First Embodiment

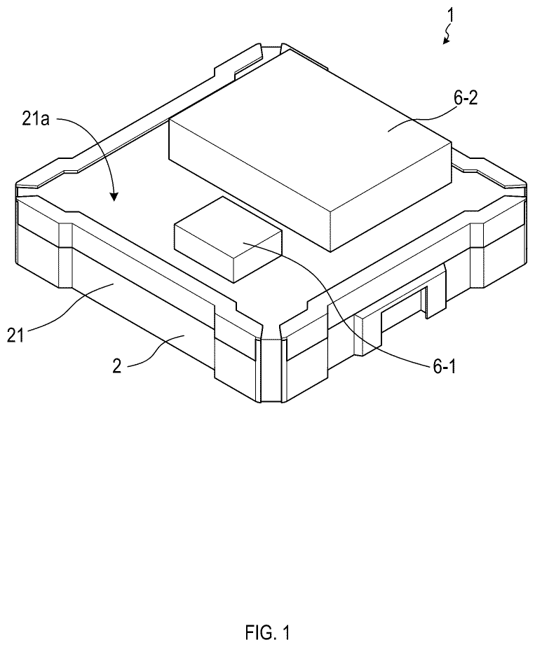

The present first embodiment provides a wireless power transmission system 1 shown in FIG. 1.

### 2-1-1. Overall Configuration of Wireless Power Transmission System

As shown in FIG. 1, the wireless power transmission system 1 includes a power transmission device 2 and first through nth power receiving devices 6-1 through 6-n (n is any natural number larger than or equal to two). FIG. 1 shows only the first and second receiving devices 6-1 and 6-2 for illustrative purposes only. In another embodiment, the nth power receiving device 6-n may be excluded from the wireless power transmission system 1.

The power transmission device 2 includes a casing 21. In the present first embodiment, the casing 21 has an external shape in the form of a substantially low-profile rectangular body. In another embodiment, the casing 21 may have any other external shape.

The casing 21 includes an upper surface 21a configured such that at least any one of the first through nth power receiving devices 6-1 through 6-n is placed thereon. In the present first embodiment, the upper surface 21a has a substantially square planar shape. In another embodiment, the upper surface 21a may have any other planar shape.

Each of the first through nth power receiving devices 6-1 through 6-n may be a job-site electrical device or a battery pack for the job-site electrical device.

In the present first embodiment, the job-site electrical device may be an electric work machine, a lighting device, an electric fan, an electric hot and cold storage unit, a radio, an electric air pump, a laser level, a portable power supply, or a power distributor. The job-site electrical device may include a battery cell therein or may be configured such that a battery pack is detachably attached thereto.

Examples of the electric work machine include, but are not limited to, an electric power tool, an electric vacuum cleaner, an electric grass cutter, and an electric garden tool.

The power distributor may include one or more ports that output electric power. Examples of the one or more ports include, but are not limited to, a terminal to be connected or coupled to a battery pack, a USB terminal, and a DC plug.

In the following, the first through nth receiving devices 6-1 through 6-n are collectively referred to as ‘receiving device 6’ without distinction.

### 2-1-2. Electrical Configuration of Wireless Power Transmission System

### 2-1-2-1. Electrical Configuration of Power Transmission Device

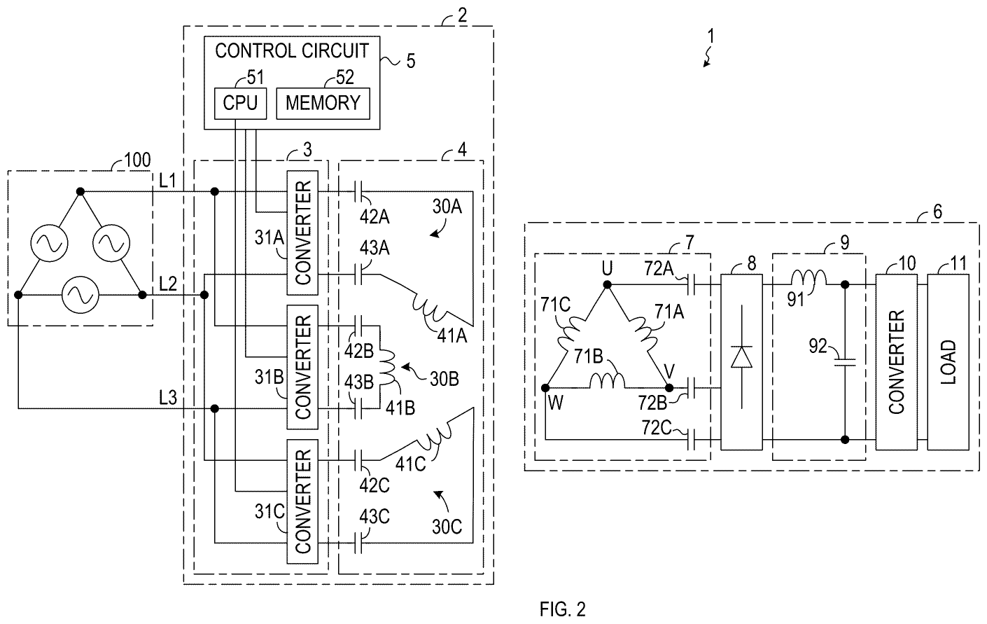

As shown in FIG. 2, the power transmission device 2 is configured to receive three-phase AC power from a three-phase AC power source 100 for operation. In the present first embodiment, the three-phase AC power source 100 is, but not limited to, a 200-volt three-phase, three-wire power source.

The power transmission device 2 includes a group of converters 3, a power transmission circuit 4, and a control circuit 5 within the casing 21.

The group of converters 3 includes first through third power transmitting converters 31A through 31C.

The first power transmitting converter 31A is coupled to L1-phase (or A-phase, or R-phase) and L2-phase (or B-phase, or S-phase) of the three-phase AC power source 100. The second power transmitting converter 31B is coupled to the L2-phase and L3-phase (or C-phase, or T-phase) of the three-phase AC power source 100. The third power transmitting converter 31C is coupled to the L3-phase and the L1-phase of the three-phase AC power source 100.

Each of the first through third power transmitting converters 31A through 31C is configured to output a single-phase AC power having a preset supply voltage and a preset transmission frequency. In the present first embodiment, the preset supply voltage is, but not limited to, 90 volts. The preset transmission frequency is, but not limited to, 6.78 megahertz.

The power transmission circuit 4 includes first through third transmitting blocks 30A through 30C configured to operate in a similar manner.

The first transmitting block 30A includes a first transmitting coil 41A, a first capacitor 42A, and a second capacitor 43A. Both ends of the first transmitting coil 41A are coupled to outputs of the first power transmitting converter 31A via the first and second capacitors 42A and 43A.

The second transmitting block 30B includes a second transmitting coil 41B, a third capacitor 42B, and a fourth capacitor 43B. Both ends of the second transmitting coil 41B are coupled to outputs of the second power transmitting converter 31B via the third and fourth capacitors 42B and 43B.

The third transmitting block 30C includes a third transmitting coil 41C, a fifth capacitor 42C, and a sixth capacitor 43C. Both ends of the third transmitting coil 41C are coupled to outputs of the third power transmitting converter 31C via the fifth and sixth capacitors 42C and 43C.

The first through third transmitting coils 41A through 41C have substantially the same characteristics. The first, third, and fifth capacitors 42A through 42C and the second, fourth, and sixth capacitors 43A through 43C have substantially the same characteristics.

The first through third transmitting coils 41A through 41C form, together with the first, third, and fifth capacitors 42 A through 42C and the second, fourth, and sixth capacitors 43 A through 43C, three series resonant circuits that resonate at the above-mentioned preset transmission frequency. The first through third transmitting coils 41A through 41C are arranged on an underside of the upper surface 21a such that magnetic flux is radiated toward the upper surface 21a.

The control circuit 5 is in the form of a microcomputer (or a microprocessor, or a microcontroller) including at least a central processing unit (CPU) 51 and a memory 52. The memory 52 is, but not limited to, a semiconductor memory including a volatile memory and a non-volatile memory.

In another embodiment, the control circuit 5 may include an additional microcomputer. In yet another embodiment, the control circuit 5 may include, in addition to or in place of the microcomputer, a graphics processing unit (GPU), a neural processing unit (NPU), an artificial intelligence (AI) processor, and/or an AI chip. In yet another embodiment, the control circuit 5 may include, in addition to or in place of the microcomputer, a logic circuit (or a logic gate, or a wired logic connection) including two or more circuit elements. In yet another embodiment, the control circuit 5 may include, in addition to or in place of the microcomputer, an application-specific integrated circuit (ASIC) and/or an application-specific standard product (ASSP). In yet another embodiment, the control circuit 5 may include, in addition to or in place of the microcomputer, a programmable logic device (PLD) on which a reconfigurable logic circuit can be implemented. Examples of the PLD include, but are not limited to, a field-programable gate array (FPGA).

The control circuit 5 controls the first through third power transmitting converters 31A through 31C such that the phases of the single-phase alternating currents supplied individually from the first through third power transmitting converters 31A through 31C to their corresponding transmitting coils 41A through 41C differ by 120 degrees (i.e., by 2π/3 radians). This causes the first through third transmitting coils 41A through 41C to simulate a delta configuration (or to form an electric circuit equivalent to a delta configuration (or a delta connection)).

### 2-1-2-2. Electrical Configuration of Power Receiving Device

As shown in FIG. 2, the power receiving device 6 includes a power receiving circuit 7, a rectifier circuit 8, a filter circuit 9, a power receiving converter 10, and a load 11.

The power receiving circuit 7 includes first through third receiving coils 71A through 71C and first through third capacitors 72A through 72C.

The first through third receiving coils 71A through 71C are connected in a delta configuration. The first through third receiving coils 71A through 71C have substantially the same characteristics.

The first through third capacitors 72A through 72C are coupled respectively to connection points U, V, and W of the first through third receiving coils 71A through 71C. The first through third capacitors 72A through 72C supply, to the rectifier circuit 8, the three-phase AC power output from the connection points U, V, and W. The first through third capacitors 72A through 72C have substantially the same characteristics. The first through third capacitors 72A through 72C form, together with the first through third receiving coils 71A through 71C, three series resonant circuits. The three series resonant circuits are configured to resonate at the above-mentioned preset transmission frequency. In other words, the power transmission circuit 4 and the power receiving circuit 7 are configured to transfer the electric power between the power transmission device 2 and the power receiving device 6 through magnetic resonance.

The rectifier circuit 8 is configured to convert the three-phase AC power output from the power receiving circuit 7 into first DC power through full-wave rectification. In the first embodiment, the rectifier circuit 8 is, but not limited to, a three-phase bridge rectifier circuit (or a three-phase full-wave rectifier) that includes not-shown six diodes or not-shown six thyristors.

The filter circuit 9 is configured to remove fifth and higher-order harmonic components included in the output from the rectifier circuit 8. In the first embodiment, the filter circuit 9 is, but not limited to, a low-pass filter configured with a coil 91 and a capacitor 92 in a low-pass filter arrangement.

The power receiving converter 10 is configured (i) to receive the first DC power through the filter circuit 9, (ii) to convert the first DC power into an output power corresponding to the load 11, and (iii) to supply (or deliver) the output power to the load 11.

The load 11 may be (i) a battery cell(s), (ii) a light source (such as a light emitting diode (LED)), (iii) an actuator (such as an electric motor), (iv) a drive circuit configured to drive an actuator, or (v) a connector configured to be coupled to a not-shown external load.

### 2-1-3. Technical Effects in First Embodiment

The first embodiment detailed above can exhibit the following first through third technical effects.

### 2-1-3-1. First Technical Effect

In the wireless power transmission system 1, the power transmission device 2 wirelessly transmits the three-phase AC power from the first through third transmitting coils 41A through 41C to the power receiving device 6. The power receiving device 6 wirelessly receives the three-phase AC power by the first through third receiving coils 71A through 71C connected in the delta configuration.

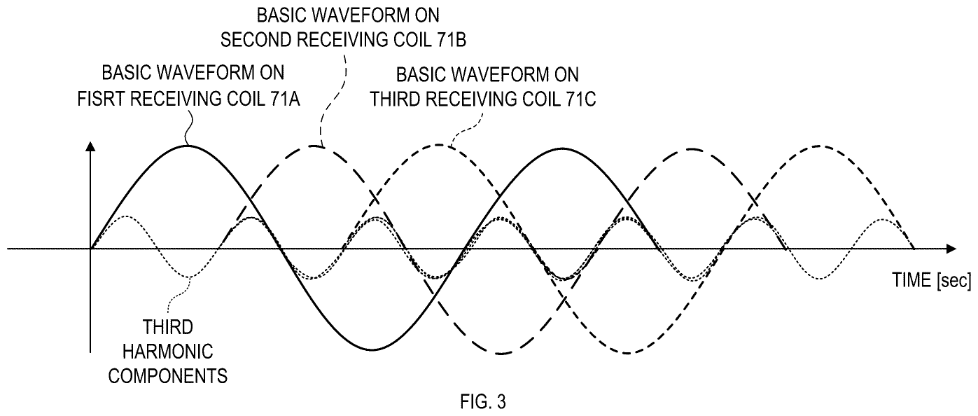

As shown in FIG. 3, the first through third receiving coils 71A through 71C generate three third harmonic components in response to the first through third receiving coils 71A through 71C receiving the three-phase AC power. These third harmonic components circulate within the delta configuration, thereby being inhibited from flowing out of the power receiving circuit 7.

Accordingly, the filter circuit 9 does not need to remove the third harmonic components, which have the largest power among unnecessary harmonic components. It is sufficient for the filter circuit 9 to remove the fifth and higher-order harmonic components, which have higher frequencies and less power compared to the third harmonic components. As a result, it is possible to downsize the filter circuit 9, thereby inhibiting an increase in size of the power receiving device 6.

Now, a description will be given of the circulation of the third harmonic components within the delta configuration.

Three harmonic components iₐ through i_{c} generated by the first through third receiving coils 71A through 71C are expressed by the following Equations (1) through (3).

$${i}_{a} = sin ( ω t ) \qquad ( 1 )$$

$${i}_{b} = sin ( ω t - \frac{2}{3} π ) \qquad ( 2 )$$

$${i}_{c} = sin ( ω t - \frac{4}{3} π ) \qquad ( 3 )$$

The third harmonic components iₐ₃ through i_{c3} are expressed by the following Equations (4) through (6).

$${i}_{a 3} = i \cdot sin ( 3 ω t ) \qquad ( 4 )$$

$${i}_{b 3} = i \cdot sin 3 ( ω t - \frac{2}{3} π ) \qquad ( 5 )$$

$${i}_{c 3} = i \cdot sin 3 ( ω t - \frac{4}{3} π ) \qquad ( 6 )$$

By simplifying Equations (5) and (6), the following Equations (7) and (8) can be obtained.

$${i}_{b 3} = i \cdot sin ( 3 ω t - 2 π ) \qquad ( 7 )$$

$${i}_{c 3} = i \cdot sin ( 3 ω t - 4 π ) \qquad ( 8 )$$

As obvious from Equations (4), (7), and (8), the third harmonic components iₐ₃ through i_{c3} are all in phase and have the same magnitude (or the same amplitude).

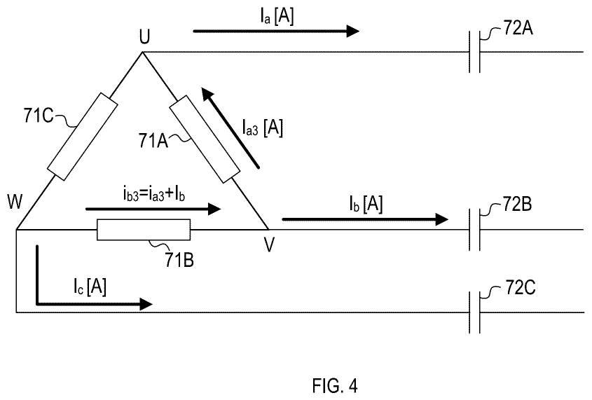

As shown in FIG. 4, the third harmonic components flowing out of the connection points U, V, and W are referred to as Iₐ, I_{b}, and I_{c}, respectively. The third harmonic component i_{b3} flowing through the second receiving coil 71B is a sum of the third harmonic component I_{b} flowing out of the connection point V and the third harmonic component iₐ₃ flowing through the first receiving coil 71A, as expressed by the following Equation (9).

$${i}_{b 3} = {i}_{a 3} + {I}_{b} \qquad ( 9 )$$

As obvious from Equations (4) and (7), since the third harmonic component iₐ₃ equals the third harmonic component i_{b3}, the third harmonic component I_{b} flowing out of the connection point V is zero. This is also applicable to the third harmonic components Iₐ, and I_{c} flowing out of the connection points U and W. Accordingly, the third harmonic components iₐ₃, i_{b3}, and i_{c3} do not flow out of the delta configuration but circulate within the delta configuration.

Next, a description will be given of the size of the filter circuit 9.

When the power transmission between the power transmission device 2 and the power receiving device 6 uses the preset transmission frequency of 6.78 megahertz, the third harmonic components have a frequency of 20.34 megahertz and the fifth harmonic components have a frequency of 33.9 megahertz. The inventor assumed that the filter circuit 9 (i.e., the low-pass filter) has an impedance of 100 ohms and a fixed capacitance of 800 picofarads.

Under such conditions, the inventor calculated the inductance of the low-pass filter that provides a gain of −20 decibels (dB) at the frequency of the third harmonic components, and then roughly estimated a volume for each coil to achieve the calculated inductance with two coils.

As a result of the calculation, the inventor obtained a volume of 0.792 milliliters (=12 mm×11 mm×6 mm) for each coil.

At the frequency of the fifth harmonic components, the inventor obtained a volume of 0.147 milliliters (=7 mm×6 mm×3.5 mm) for each coil, under the same conditions.

Accordingly, a space occupied by the coil 91 can be reduced to ⅕ or less, if the filter circuit 9 is not required to remove the third harmonic components.

### 2-1-3-2. Second Technical Effect

In the power transmission device 2, the first through third transmitting blocks 30A through 30C are driven individually. Thus, when any one of the first through third transmitting blocks 30A through 30C fails, the power transmission can be continued by the remaining two transmitting blocks. Accordingly, the power transmission device 2 has improved reliability. In this case, the control circuit 5 may control the remaining two transmitting blocks so as not to decrease the power transmitted to the power receiving device 6.

### 2-1-3-3. Third Technical Effect

In the power receiving device 6, the first through third receiving coils 71A through 71C are connected in the delta configuration. Therefore, when any one of the first through third receiving coils 71A through 71C fails (for example, due to breakage), the power reception can be continued by the remaining two receiving coils. Accordingly, the power receiving device 6 has improved reliability.

### 2-1-4. Correspondence Between Terms

In the present first embodiment, the power transmission circuit 4 corresponds to one example of the first power transmission circuit in Overview of Embodiments. The first through third transmitting coils 41A through 41C correspond to examples of the two or more transmitting coils and also examples of the three transmitting coils in Overview of Embodiments. A combination of the group of converters 3 with the control circuit 5 corresponds to one example of the power supply circuit in Overview of Embodiments. The preset transmission frequency is one example of the identical frequency in Overview of Embodiments. The power receiving circuit 7 corresponds to the first power receiving circuit in Overview of Embodiments. The first through third receiving coils 71A through 71C correspond to examples of the three receiving coils in Overview of Embodiments. A combination of the rectifier circuit 8 with the filter circuit 9 corresponds to one example of the conversion circuit in Overview of Embodiments. The rectifier circuit 8 corresponds to one example of the first rectifier circuit in Overview of Embodiment.

### 2-1-5. Variations of First Embodiment

Any one of the first through third transmitting blocks 30A through 30C may be removed from the power transmission device 2.

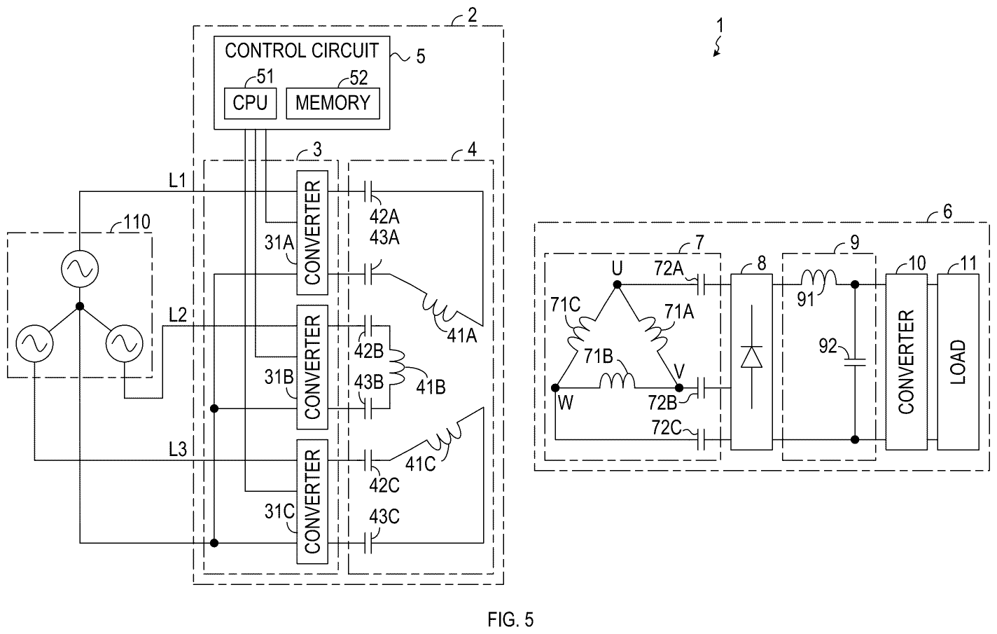

Additionally or alternatively, as shown in FIG. 5, the power transmission device 2 may be configured to receive the three-phase AC power from a three-phase AC power source 110 in place of the three-phase AC power source 100. The three-phase AC power source 110 is a 200-volt three-phase four-wire power source.

In this case, in addition to the electric wires corresponding respectively to the L1-phase, the L2-phase, and the L3-phase, an additional electric wire (i.e., a neutral wire) is required to provide a reference potential to the power transmission device 2.

The first power transmitting converter 31A is coupled to the three-phase AC power source 110 so as to receive a voltage between the L1-phase and the neutral wire. The second power transmitting converter 31B is coupled to the three-phase AC power source 110 so as to receive a voltage between the L2-phase and the neutral wire. The third power transmitting converter 31C is coupled to the three-phase AC power source 110 so as to receive a voltage between the L3-phase and the neutral wire.

Additionally or alternatively, the first through third transmitting coils 41A through 41C may be connected in a star configuration.

### 2-2. Second Embodiment

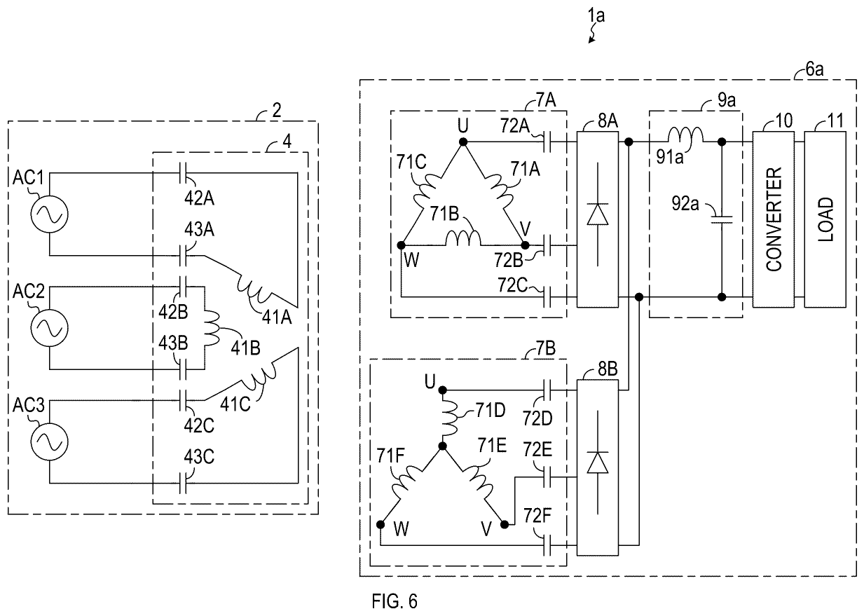

The present second embodiment provides a wireless power transmission system 1a shown in FIG. 6. The wireless power transmission system 1a is obtained by partially modifying the wireless power transmission system 1 in the first embodiment. Thus, the following descriptions focus only on the parts modified from the first embodiment. The parts common to those in the first embodiment are identified by the same reference numerals, and detailed descriptions thereof are omitted.

### 2-2-1. Differences from First Embodiment

As shown in FIG. 6, the wireless power transmission system 1a includes a power receiving device 6a in place of the power receiving device 6.

In FIG. 6, the configuration of the power transmission device 2 is shown in a partially simplified manner. Specifically, the three-phase AC power source 100, the first through third power transmitting converters 31A through 31C, and the control circuit 5 are shown as first through third AC power sources AC1 through AC3. Accordingly, each of the first through third AC power sources AC1 through AC3 is configured to output the single-phase AC power described in the first embodiment.

### 2-2-2. Electrical Configuration of Power Receiving Device

The power receiving device 6a is different from the power receiving device 6 in the first embodiment in that the power receiving circuit 6a includes first and second power receiving circuits 7A and 7B, first and second rectifier circuits 8A and 8B, and a filter circuit 9a, in place of the power receiving circuit 7, the rectifier circuit 8, and the filter circuit 9.

The first power receiving circuit 7A has the same configuration as that of the power receiving circuit 7 in the first embodiment.

The second power receiving circuit 7B includes fourth through sixth receiving coils 71D through 71F and fourth through sixth capacitors 72D through 72F.

The fourth through sixth receiving coils 71D through 71F (i) have substantially the same characteristics and (ii) are connected in a star configuration. Accordingly, the fourth through sixth receiving coils 71D through 71F include respective first ends connected together.

The fourth through sixth capacitors 72D through 72F (i) have substantially the same characteristics and (ii) are coupled to second ends of the fourth through sixth receiving coils 71D through 71F, respectively. The fourth through sixth capacitors 72D through 72F provide, to the second rectifier circuit 8B, the three-phase AC power output from the fourth through sixth receiving coils 71D through 71F. The fourth through sixth capacitors 72D through 72F form, together with the fourth through sixth receiving coils 71D through 71F, three additional series resonant circuits. These additional series resonant circuits are configured to resonate at the aforementioned preset transmission frequency.

The first rectifier circuit 8A has the same configuration as that of the rectifier circuit 8 in the first embodiment.

The second rectifier circuit 8B has the same configuration as that of the first rectifier circuit 8A but is configured to convert, into second DC power, the three-phase AC power output from the second power receiving circuit 7B.

The second DC power is combined in parallel with the first DC power output from the first rectifier circuit 8A and supplied to the filter circuit 9a.

Similarly with the filter circuit 9, the filter circuit 9a is a low-pass filter configured with a coil 91a and a capacitor 92a in a low-pass filter arrangement. However, the filter circuit 9a is different from the filter circuit 9 in that the filter circuit 9a is set to remove eleventh and higher-order harmonic components included in the first and second DC powers combined together.

### 2-2-3. Technical Effects in Second Embodiment

The second embodiment detailed above can exhibit, in addition to the first through third technical effects, the following fourth technical effect.

### 2-2-3-1. Fourth Technical Effect

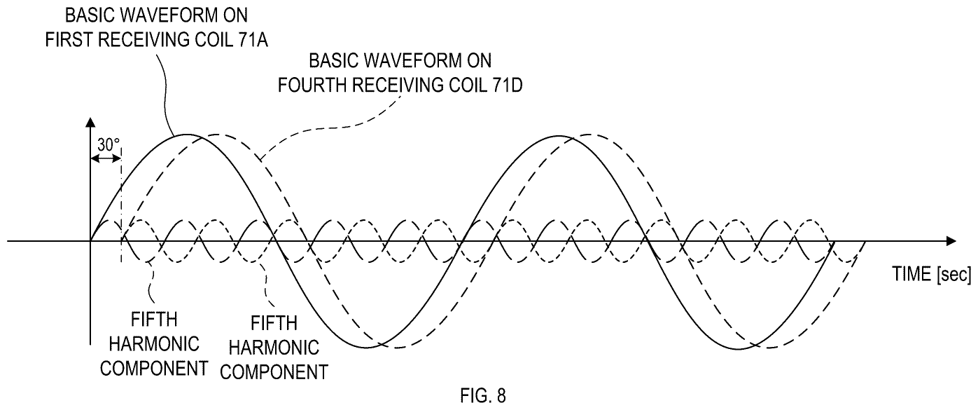

As shown in FIG. 8, in the wireless power transmission system 1a, the output currents from the fourth through sixth receiving coils 71D through 71F connected in the star configuration are shifted in phase by 30 degrees relative to the respective output currents from the first through third receiving coils 71A through 71C connected in the delta configuration. Although FIG. 8 shows the respective waveforms of the output current from the fourth receiving coil 71D and the output current from the first receiving coil 71A, the respective waveforms of the output current from the fifth receiving coil 71E and the output current from the second receiving coil 71B, and the respective waveforms of the output current from the sixth receiving coil 71F and the output current from the third receiving coil 71C are similar with the waveforms shown in FIG. 8, except that their phases are shifted by 120 degrees or 240 degrees. The fifth harmonic component generated by the fourth receiving coil 71D is generally inverted with respect to the fifth harmonic component generated by the first receiving coil 71A. The fifth harmonic component generated by the fifth receiving coil 71E is generally inverted with respect to the fifth harmonic component generated by the second receiving coil 71B. The fifth harmonic component generated by the sixth receiving coil 71F is generally inverted with respect to the fifth harmonic component generated by the third receiving coil 71C. Therefore, by performing full-wave rectification on the outputs from the first and second power receiving circuits 7A and 7B and combining them, the fifth harmonic components are suppressed. The seventh harmonic components are also suppressed in the same way.

Generally, as a measure to reduce harmonic components in semiconductor application equipment, use of three-phase transformers in combination is a known technique for increasing the number of output phases. In the first embodiment, since the full-wave rectification is applied to the one set of three-phase AC power, the number of output phases is six. In the second embodiment, the full-wave rectification is applied to the two mutually phase-shifted sets of three-phase AC power, the number of output phases is twelve.

It is known that the harmonic components to be generated have an order n expressed by the following Equation (10).

$$n = m p \pm 1 \qquad ( 10 )$$

where m is any natural number larger than or equal to one, and p is the number of output phases.

Accordingly, the filter circuit 9a of the power receiving device 6a with twelve output phases is not required to remove the seventh and lower-order harmonic components and sufficient to remove the eleventh and higher-order harmonic components, which have higher frequencies and less power. As a result, the filter circuit 9a can be downsized further than the filter circuit 9.

### 2-2-4. Correspondence Between Terms

In the present second embodiment, the second power receiving circuit 7B corresponds to one example of the second power receiving circuit in Overview of Embodiments. The fourth through sixth receiving coils correspond to examples of the three additional receiving coils in Overview of Embodiments. The second rectifier circuit 8B corresponds to one example of the second rectifier circuit in Overview of Embodiments.

### 2-2-5. Variations of Second Embodiment

The fourth through sixth receiving coils 71D through 71F may be connected in a delta configuration. In this case, the power receiving device 6a may include, in place of the filter circuit 9a, the filter circuit 9 in the first embodiment in order to remove the fifth and higher-order harmonic components. Additionally or alternatively, the first through third transmitting coils 41A through 41C may be connected in a star configuration.

### 2-3. Third Embodiment

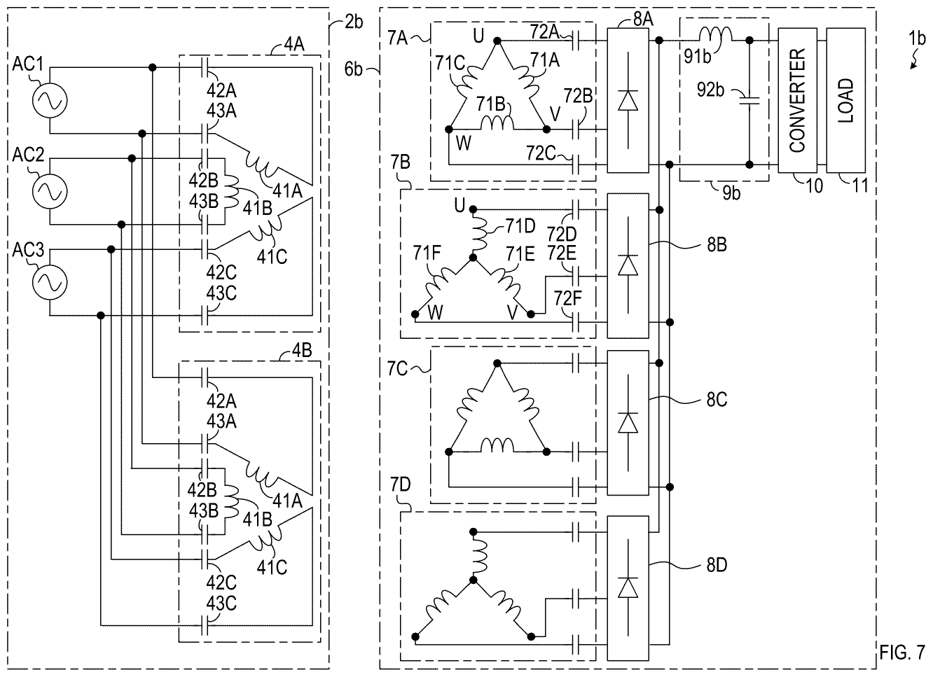

The present third embodiment provides a wireless power transmission system 1b shown in FIG. 7. The wireless power transmission system 1b is obtained by partially modifying the wireless power transmission system 1a in the second embodiment. Thus, the following descriptions focus only on the parts modified from the second embodiment. The parts common to those in the second embodiment are identified by the same reference numerals, and detailed descriptions thereof are omitted.

### 2-3-1-. Differences from Second Embodiment

As shown in FIG. 7, the wireless power transmission system 1b includes a power transmission device 2b and a power receiving device 6b, in place of the power transmission device 2 and the power receiving device 6a.

### 2-3-2. Electrical Configuration of Power Transmission Device

The power transmission device 2b includes first and second power transmission circuits 4A and 4B. The first and second power transmission circuits 4A and 4B are coupled in parallel to each other. The first and second power transmission circuits 4A and 4B are configured (i) to receive the respective single-phase AC powers from the first through third AC power sources AC1 through AC3 and (ii) to operate in phase with each other. Specifically, each of the first and second power transmission circuits 4A and 4B has the same configuration as that of the power transmission circuit 4 in the second embodiment.

### 2-3-3. Electrical Configuration of Power Receiving Device

The power receiving device 6b is different from the power receiving device 6a in that (i) the power receiving device 6b includes third and fourth power receiving circuits 7C and 7D, and third and fourth rectifier circuits 8C and 8D, in addition to the first and second power receiving circuits 7A and 7B, and the first and second rectifier circuits 8A and 8B, and (ii) the power receiving circuit 6b includes a filter circuit 9b in place of the filter circuit 9a.

The third power receiving circuit 7C has the same configuration as that of the first power receiving circuit 7A. The fourth power receiving circuit 7D has the same configuration as that of the second power receiving circuit 7B.

The third rectifier circuit 8C has the same configuration as that of the first rectifier circuit 8A but is configured to convert, into third DC power, three-phase AC power output from the third power receiving circuit 7C.

The fourth rectifier circuit 8D has the same configuration as that of the first rectifier circuit 8A but is configured to convert, into fourth DC power, three-phase AC power output from the fourth power receiving circuit 7D.

The first through fourth DC powers are combined in parallel and supplied to the filter circuit 9b.

Similarly with the filter circuit 9a, the filter circuit 9b is a low-pass filter configured with a coil 91b and a capacitor 92b in a low-pass filter arrangement. However, the filter circuit 9b is different from the filter circuit 9a in that the filter circuit 9b is set to remove the eleventh and higher-order harmonic components included in the first through fourth DC powers combined together.

### 2-3-4. Technical Effects in Third Embodiment

The third embodiment detailed above can exhibit, in addition to the first through fourth technical effects, the following fifth technical effect.

### 2-3-4-1. Fifth Technical Effect

With the first and second power transmission circuits 4A and 4B, and the first through fourth power receiving circuits 7A through 7D, the wireless power transmission system 1b can achieve greater power transmission capability than that of the wireless power transmission system 1a in the second embodiment.

Alternatively, in a case where the power transmission capability of the wireless power transmission system 1b is set to be equivalent to that of the wireless power transmission system 1a, it is possible to reduce the maximum ratings (such as rated temperature and rated current) required for circuit elements of the first and second power transmission circuits 4A and 4B and the first through fourth power receiving circuits 7A through 7D in the wireless power transmission system 1b. As a result, less expensive circuit elements can be used for the first and second power transmission circuits 4A and 4B and the first through fourth power receiving circuits 7A through 7D.

### 2-3-5. Correspondence Between Terms

In the present third embodiment, the second power transmission circuit 4B corresponds to one example of the second power transmission circuit in Overview of Embodiments. The first through third transmitting coils 41A through 41C in the second power transmission circuit 4B correspond to examples of the two or more additional transmitting coils and also examples of the three additional transmitting coils in Overview of Embodiments. The second power receiving circuit 7B, the third power receiving circuit 7C, or the fourth power receiving circuit 7D corresponds to one example of the second power receiving circuit in Overview of Embodiments.

### 2-3-6. Variations of Third Embodiment

The first and second power transmission circuits 4A and 4B may be configured to operate with a specified phase shift (for example, a 15-degree phase shift) relative to each other.

Additionally or alternatively, the wireless power transmission system 1b may be configured such that (i) the first power transmission circuit 4A transmits the three-phase AC power to the first and second power receiving circuits 7A and 7B, and (ii) the second power transmission circuit 4B transmits the three-phase AC power to the third and fourth power receiving circuits 7C and 7D. In this case, the number of output phases in the power receiving device 6b is 24. Accordingly, as obvious from Equation (10), the filter circuit 9b is sufficient to remove twenty-third and higher-order harmonic components.

Additionally or alternatively, the first through third transmitting coils 41A through 41C in the first power transmission circuit 4A and/or the first through third transmitting coils 41A through 41C in the second power transmission circuit 4B may be star-connected.

Additionally or alternatively, the three receiving coils in the third power receiving circuit 7C may be star-connected.

Additionally or alternatively, the three receiving coils in the second power receiving circuit 7B and/or the three receiving coils in the fourth power receiving circuit 7D may be delta-connected.

### 2-4. Further Embodiments

Although the embodiments of the present disclosure have been described so far, the present disclosure can be implemented in variously modified manners without being limited to the aforementioned first through third embodiments.

In a further embodiment, one or more additional power transmission devices and/or one or more additional power receiving devices may be provided with any one of the wireless power transmission systems 1, 1a, and 1b.

### 2-5. Supplementary Explanation

Two or more functions achieved by one element of the above-described embodiments may be achieved by two or more elements. One function achieved by one element may be achieved by two or more elements. Two or more functions achieved by two or more elements may be achieved by one element. One function achieved by two or more elements may be achieved by one element. A part of the configurations in the above-described embodiments may be omitted. At least a part of the configurations in one of the above-described embodiments may be added to or replaced with the configurations in another one of the above-described embodiments.

What is claimed is:

1. A wireless power transmission system comprising:
a power transmission device and a power receiving device,
the power transmission device including:
a first power transmission circuit including two or more transmitting coils, the two or more transmitting coils being separated from each other; and
a power supply circuit configured to supply two or more single-phase alternating currents to the two or more transmitting coils, respectively, the two or more single-phase alternating currents having an identical frequency but differing in phase from each other, and
the power receiving device including:
a first power receiving circuit including three receiving coils connected in a delta configuration, the three receiving coils being configured (i) to be magnetically coupled with the two or more transmitting coils and (ii) to output a first polyphase AC power in response to the two or more single-phase alternating currents being supplied to the two or more transmitting coils, respectively; and
a conversion circuit configured to convert the first polyphase AC power into first DC power.

2. The wireless power transmission system according to claim 1,
wherein the conversion circuit includes:
a first rectifier circuit configured to rectify the first polyphase AC power into the first DC power; and
a filter circuit configured to remove unnecessary harmonic components from the first DC power obtained by the first rectifier circuit.

3. The wireless power transmission system according to claim 1, wherein:
the two or more transmitting coils include three transmitting coils;
the two or more single-phase alternating currents include three single-phase alternating currents that differ in phase from each other by 120 degrees;
the power supply circuit is configured to supply the three single-phase alternating currents to the three transmitting coils, respectively; and
the three transmitting coils are configured to receive the three single-phase alternating currents to thereby simulate a delta configuration.

4. The wireless power transmission system according to claim 1, wherein:
the first power transmission circuit includes two or more capacitors configured to form two or more series resonant circuits together with the two or more transmitting coils;
the first power receiving circuit includes three additional capacitors configured to form three additional series resonant circuits together with the three receiving coils; and
the two or more series resonant circuit and the three additional series resonant circuits are each configured to resonate at the identical frequency.

5. The wireless power transmission system according to claim 1, further comprising
a second power receiving circuit that is distinct from the first power receiving circuit, wherein:
the second power receiving circuit (i) includes three additional receiving coils connected in a delta configuration or in a star configuration and (ii) is configured to output a second polyphase AC power; and
the conversion circuit includes a second rectifier circuit that is configured (i) to rectify the second polyphase AC power into second DC power and (ii) to combine the second DC power with the first DC power in parallel.

6. The wireless power transmission system according to claim 1,
wherein the power receiving device is (i) a job-site electrical device or (ii) a battery pack for the job-site electrical device.

7. The wireless power transmission system according to claim 6,
wherein the conversion circuit is configured to supply at least the first DC power to a battery cell for the job-site electrical device.

8. The wireless power transmission system according to claim 1, wherein:
the power transmission device further includes a second power transmission circuit that is distinct from the first power transmission circuit; and
the second power transmission circuit includes two or more additional transmitting coils.

9. The wireless power transmission system according to claim 8,
wherein the two or more additional transmitting coils include three additional transmitting coils.

10. A power transmission device comprising:
a transmission circuit including three transmitting coils, the three transmitting coils being separated from each other; and
a power supply circuit configured to supply three single-phase alternating currents to the three transmitting coils, respectively, the three single-phase alternating currents having an identical frequency but differing in phase from each other by 120 degrees,
wherein the three transmitting coils are configured to receive the three single-phase alternating currents to thereby simulate a delta configuration.
